(19) United States
(12) Patent Application Publication
(10) Pub. No.: US 2025/0007787 A1
(43) Pub. Date: Jan. 2, 2025

(54) SYSTEM AND A METHOD FOR IMPROVING PREDICTION ACCURACY IN AN INCIDENT MANAGEMENT SYSTEM

(71) Applicant: Telefonaktiebolaget LM Ericsson (publ), Stockholm (SE)

(72) Inventors: Giuseppe BURGARELLA, Santa Clara, CA (US); Francesca MARFIA, Pagani (IT)

(21) Appl. No.: 18/696,037

(22) PCT Filed: Sep. 27, 2021
(86) PCT No.: PCT/IB2021/058809

§ 371 Date: Mar. 27, 2024

(51) Int. Cl. H04L 41/147; H04L 41/0631; H04L 41/14

(52) U.S. Cl. CPC H04L 41/147; H04L 41/0631; H04L 41/145

(57) ABSTRACT

A method and system for de-biasing data for an incident management system that includes receiving a key performance indicator (KPI) input from at least a first source and a second source, classifying the key performance indicator input as a predictable KPI or an unpredictable KPI, generating a first set of models to predict events based on the unpredictable KPI, executing the first set of models to generate predicted events for the incident management system, and outputting a set of patterns for the predicted events.

### TECHNICAL FIELD

Embodiments of the invention relate to the field of incident management; and more specifically, to a system and process for improving prediction accuracy in an incident management system.

### BACKGROUND ART

Cellular or mobile communication networks (herein after referred to as ‘mobile networks’) are widely utilized communication networks that enable communication by user equipment (UE) via a wireless link with the remainder of the mobile network, other devices accessible via the mobile network, and other connected networks. Mobile networks are distributed over large geographical areas. The components of the mobile networks that interface with UE via the wireless communication are referred to as “cells,” each cell including at least one fixed-location transceiver, but more normally, a set of transceivers referred to as a base transceiver station or base station. A ‘set,’ as used herein refers to any positive whole number of items including one item. The base stations provide access to UEs within the cell to the mobile network, which can be used for transmission of voice, data, and other types of content. A cell typically uses a different set of radio frequencies from neighboring cells, to minimize interference and provide guaranteed service quality within each cell to the UEs. Mobile network operators (MNOs) develop and maintain the mobile networks and contract with subscribers to provide service to their respective UEs.

In mobile networks cell accessibility, i.e., the functional availability of cell resources to the UE, and similar network operational performance are key operational features. Proper management of the mobile network is important for providing a high quality of service to users by the MNOs. However, mobile networks are becoming more and more complex and MNOs are often expected to deal with huge number of alarms and to make critical decisions in very short time periods. Incident management system provide a set of tools to enable MNOs to manage these networks including tools that collect key performance indicators (KPIs) from the mobile networks. The MNOs can use these KPIs to monitor the operation of the networks and take corrective action when necessary. The monitoring and corrective actions can be manual or hardcoded sets of policies for different KPIs. These manual or hardcoded solutions are inadequate for the increasing scale mobile networks and the associated resources and unable to keep up with the increasing large set of KPIs that are collected and monitored to be correlated with network issues.

### SUMMARY

In one embodiment, a method and system for de-biasing data for an incident management system that includes receiving a key performance indicator (KPI) input from at least a first source and a second source, classifying the key performance indicator input as a predictable KPI or an unpredictable KPI, generating a first set of models to predict events based on the unpredictable KPI, executing the first set of models to generate predicted events for the incident management system, and outputting a set of patterns for the predicted events.

In another embodiment, a non-transitory machine-readable storage medium has stored therein a set of instructions for a method for de-biasing data for an incident management system, which when executed by a processor of an electronic device cause the electronic device to perform a set of operations including receiving a KPI input from at least a first source and a second source, classifying the key performance indicator input as a predictable KPI or an unpredictable KPI, generating a first set of models to predict events based on the unpredictable KPI, executing the first set of models to generate predicted events for the incident management system, and outputting a set of patterns for the predicted events.

In one embodiment, an electronic device includes a non-transitory machine-readable storage medium having stored therein a de-biasing component, and a set of processors coupled to the non-transitory machine-readable storage medium, at least one processor from the set of processors to execute the de-biasing component, the de-biasing component to execute the method for de-biasing data for an incident management system, where the method includes receiving a KPI input from at least a first source and a second source, classifying the key performance indicator input as a predictable KPI or an unpredictable KPI, generating a first set of models to predict events based on the unpredictable KPI, executing the first set of models to generate predicted events for the incident management system, and outputting a set of patterns for the predicted events.

### BRIEF DESCRIPTION OF THE DRAWINGS

The invention may best be understood by referring to the following description and accompanying drawings that are used to illustrate embodiments of the invention. In the drawings:

FIG. 1 is a diagram of on example of a predictive modeling system.

FIG. 2 is a diagram of one embodiment of a de-biasing component in a data pre-processing system.

FIG. 3 is a diagram of one embodiment of a key performance indicator (KPI) processor.

FIG. 4 is a flowchart of one embodiment of a process of the KPI processor.

FIG. 5 is a diagram of one embodiment of an events processor.

FIG. 6 is a flowchart of one embodiment of a process of an events processor.

FIG. 7 is a diagram illustrating time series data.

FIG. 8 is a diagram of one embodiment of an incident management system.

FIG. 9A illustrates connectivity between network devices (NDs) within an exemplary network, as well as three exemplary implementations of the NDs, according to some embodiments of the invention.

FIG. 9B illustrates an exemplary way to implement a special-purpose network device according to some embodiments of the invention.

FIG. 9C illustrates various exemplary ways in which virtual network elements (VNEs) may be coupled according to some embodiments of the invention.

FIG. 9D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 9E illustrates the simple case of where each of the NDs implements a single NE, but a centralized control plane has abstracted multiple of the NEs in different NDs into (to represent) a single NE in one of the virtual network(s), according to some embodiments of the invention.

FIG. 9F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 10 illustrates a general purpose control plane device with centralized control plane (CCP) software 1050), according to some embodiments of the invention.

### DETAILED DESCRIPTION

The following description describes methods and apparatus for avoiding human-based bias in data-preparation phase and to improve predictive accuracy by avoiding human involvement in the data-preparation phase. In the embodiments, the data preparation is automated, and data of different nature is used. Data passes through different layers of processing and correlation to obtain homogenous data that can be used for prediction purposes.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The embodiments provide a method and system that support event prediction (e.g., alarms, incidents, and other events) using machine learning techniques. The embodiments provide reduced operating expenses for entities that utilize the method and system. The alarm prediction can be utilized as part of automated incident prediction and management services that enable users to make fast data-driven decisions. The automated incident prediction services can utilize data mining techniques to discover and extract patterns in big and heterogeneous datasets.

In incident prediction and management systems, referred to herein as “incident management systems,” the prediction problem is solved by monitoring “controlled key performance indicators (KPIs)” or “known alarms.” A “controlled KPI” can be a metric with known and predictable patterns or relationships with incidents. A “known alarm” is similarly a condition or event that has a known relationship to a problem or error in a monitored system. In both the controlled KPI and known alarms scenarios, the knowledge behind the prediction of the incident management system is hardcoded. These incident management systems utilize the controlled or “predictable” KPIs to extrapolate future values and check simple rules like threshold crossing. In some incident management systems, the analysis is limited to anomaly detection that triggers a pre-defined action (e.g., implementing a reaction mode). Data used for prediction in incident management systems are usually in the form of time series and require a time-consuming data-preparation phase to be normalized for use.

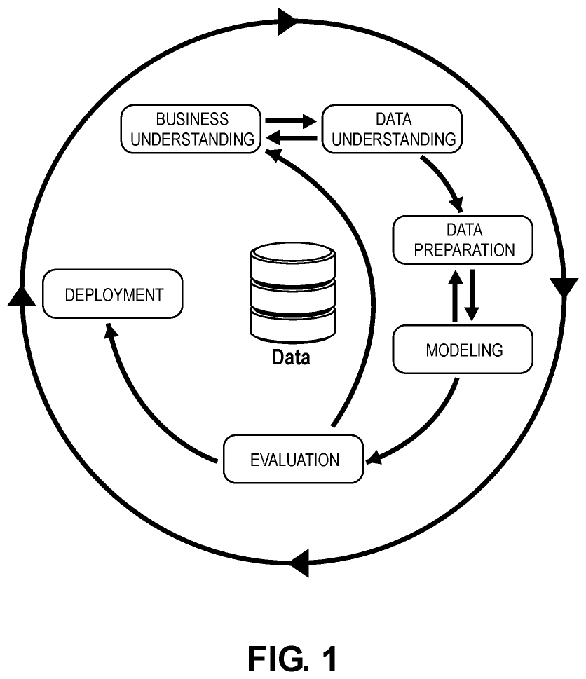

FIG. 1 is a diagram of one example of a predictive modeling system. The incident management systems can utilize predictive modeling to predict events and issues in a monitored system. Prediction modeling can broadly follow a set of basic steps as illustrated in FIG. 1 (e.g., as organized in the CRISP_DM model). The basic steps of prediction modeling can split the process of data mining into a set of (e.g., six) major phases such as business understanding, data understanding, data preparation, modeling, evaluation, and deployment. The embodiments attempt to improve the most important and time-consuming phases, which are the steps related to data (i.e., data understanding and data preparation).

These steps are the most time-consuming because the datasets for complex projects are specific, multi-variety, multi-dimensional and may contain “dirty” data. A preliminary pre-process is needed to fill holes, to filter unuseful data and eventually to transform/normalize the data. This process has utilized people skilled in the art that have a high domain expertise as well as in-depth knowledge of science, technology, and statistics. A good data pre-processing allows the prediction modeling system to get the best (i.e., most accurate) results from the application of machine learning techniques that gives machines the power to learn, to make predictions, and to avoid human intervention in repetitive tasks. However, machine learning has various downsides and can be subject to some of the pitfalls of manual processes in terms of bias in data sets, data pre-processing, and selection.

Bias can be one of the biggest challenges data scientists ace when approaching a design or operation of a machine learning (ML). Data bias in machine learning is similar to the problem of humans having a “bias” towards people. If an individual is biased toward other groups of individuals, then that individual is prone to make incorrect assumptions about the groups of individuals and members thereof. The same problem occurs in machine learning. A high bias in the operation of the ML algorithm or in the data set can cause an inaccurate prediction. Bias is a type of error in which certain elements of a dataset are more heavily weighted and/or represented than others without a factual basis and a biased dataset can be dangerous when applied to critical business cases (e.g., in a healthcare setting) since the bias can lead to skewed outcomes, low accuracy and analytical errors.

Bias can occur in each of the different stages of the prediction process. Bias can occur when collecting data to build the model, when interpreting results, and/or when testing the output of a model. In addition, there can be human-based bias occurring when humans, influenced by their cultural background, age, or socioeconomic status need to manipulate the data that is input or output from the prediction system. Machine learning bias is another type of bias that can occur when deep learning models are too specific. In an incident management system bias is a critical issue since it can lead to inaccurate results, and this could cause serious problems to the monitored systems that are being guided by the incident management system.

The embodiments overcome the problems of the art, in particular the embodiments address the issues of bias and improves prediction in an incident management system that monitors controlled KPIs and/or known alarms. The embodiments also make use of random KPIs, which are the KPI's that are not classified as ‘controlled’ or predictable, because in some cases these KPIs are associated with sporadic events, which can be classified as anomalies. The embodiments provide a system and a method for avoiding human-based bias in data-preparation phase and to improve predictive accuracy leveraging automated processes (i.e., processes that exclude human bias). This data preparation is automated, and data of a different and varied nature is used than the controlled KPIs used in existing systems. Data, including new and varied types of data, passes through different layers of processing and correlation to obtain homogenous data that can be used for prediction purposes in an incident management system.

The embodiments introduce a method and system that can autonomously pre-process data of different and varied natures avoiding human-bias. The embodiments solve the problem of bias introduced by human intervention in data preprocessing by using a multi-layered system able to take information from data of different and varied natures and after the different multi-layered stages of processing is able to provide a homogeneous dataset to be used for prediction purposes. The embodiments provide several advantages for users of the incident management system, the operation of the incident management system, and the operation of the monitored and managed systems. Machine learning based projects are time and resource consuming in the early stages of their operation such as in the data collection and data preparation stages. These stages require a high level human capital in terms of skills and time required. Yet, this investment of human capital does not avoid low accuracy in the results. The embodiments provide the benefits of avoiding the time spent preparing data and significantly reduces bias while improving accuracy. The proposed mechanism for improving accuracy compensates for the missing human intervention in the early stages of the process without incurring the associated bias. Other advantages of the embodiments include a reduced time to establish an incident management project.

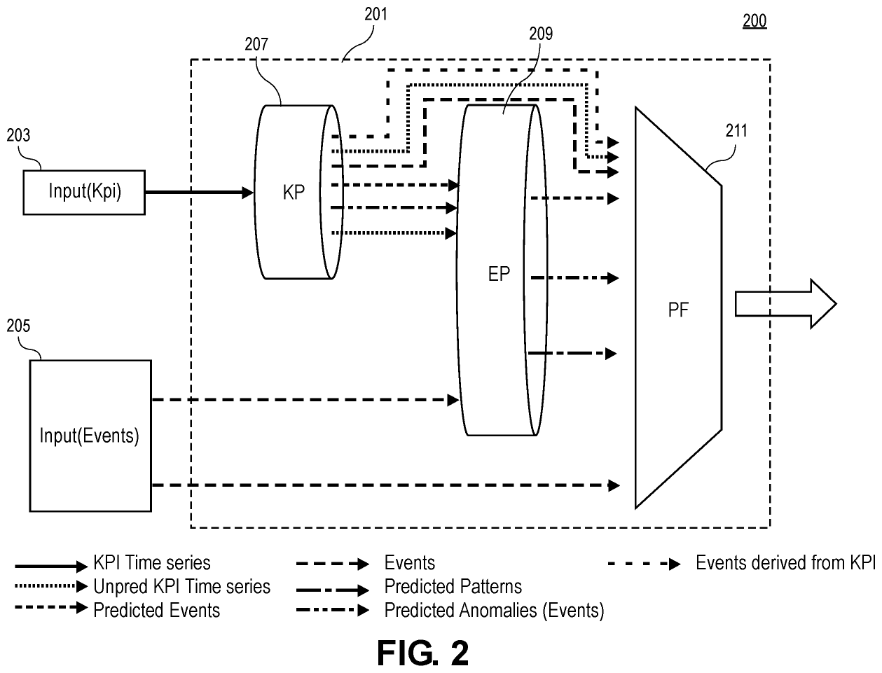

FIG. 2 is a diagram of one embodiment of a de-biasing component in a data pre-processing system. The de-biasing component can be part of an incident management system. An incident management system is an application that helps an information technology administrative team to limit the impacts of service outages or disruptions, by anticipating the service outages and disruptions and more quickly recovering from the outages and disruptions. Incident management is the process of managing problems happening in a monitored system such as a telecommunications network. In the example of a telecommunications network the incident management system can monitor for broken transport links, network cell unavailability, and similar service outages and disruptions.

The incident management systems utilize machine learning to create predictive models that process real-time data of the operations of the monitored system to predict near future service outages and disruptions in the monitored systems that are caused by component failures, congestion, or similar events in the monitored system. The use of predictive models has some drawbacks since to be accurate the predictive models need a large amount of data that needs to be carefully analyzed by human experts in the domain of the monitored system, in statistics/mathematics, and this requires a huge effort and lot of time to produce data sets that enable training of the predictive models that generate accurate results. In addition, in many computer related domains (e.g., telecommunication networks) the data collection time window is very important, because data older that a specific time window are considered obsolete and sometimes the amount of data required to train a predictive machine learning model requires data covering a longer time window.

The human intervention in the data preparation process can cause unreliable results because the human intervention is affected by human bias. The long processing time required for training predictive models (e.g., neural networks) can require data that can be considered obsolete if belonging to a wide time window. To solve all these problems, the embodiments provide a system and a method for improving accuracy in an incident management system that does not require ore rely upon human intervention in the data preparation phase. The embodiments process a heterogeneous dataset made of measured key performance indicators and other data representing factors that can influence results. In some data sources collected from a target system, it is possible to observe recurrent pattern in KPIs (e.g., data throughput can be higher in specific time windows). In some other data sources, when something unexpected occurs then an unknown pattern appears. Having the knowledge of the factors that influence that result can help in providing a KPI forecast. To achieve modeling where there is an unknown pattern in the data an approach to find the relationship between the relevant factors and KPI is needed.

As used herein, an “event,” is a message generated by an application when something planned or unplanned happens. An “alarm” is a message generated by an application when something problematic occurs that requires a corrective action. A “key performance indicator” is an indicator, i.e., a metric, used to measure and evaluate the behavior or capacity of a monitored system (e.g., a telecommunication network). The embodiments are described in relation to an incident management system that is applied to a telecommunication network by way of example and not limitation. One skilled in the art would appreciate that the principles, methods, and structures discussed herein with regard to these example embodiments are applicable to other implementations and contexts.

The embodiments provide an autonomous solution for creating insights from multiple types of input data sources (i.e., in the learning phase). The embodiments operate to identify different types of events including configuration management (CM), performance management (PM), and fault management (FM) events. In addition, the embodiments identify anomalies and events derived from predictable KPIs. The embodiments also utilize “random” KPIs (i.e., KPIs that are not considered to be predictable using prior methodology) that can be correlated to a specific alarm (or generic problem, referred to herein as an “incident”). The embodiments also provide a method and system to predict future occurrences of each specific incident (i.e., in the prediction phase).

In reference to FIG. 2, a portion of an incident management system 200 is shown that includes a de-biasing component 201. The de-biasing component includes a KPI processor (KP) 207, event processor (EP) 209, and prediction and filter block (PF) 211. The KPI processor 207 and event processor 209 receive a set of KPI inputs 203 and a set of event inputs 205. The KPI processor 207 feeds a set of outputs into the event processor 209, which in turn feeds a set of inputs into a prediction and filter block 211 that generates a prediction for the incident management system 200.

The inputs 203, 205 include dishomogeous data including KPIs 203 and events 203. KPIs are key performance indicators which are a set of metrics and numeric values in the form of a time series. Events are messages and can have various types, formats, fields, and values dependent on the event which can include notifications or alarms. The input data 203, 205 is passed through different layers (i.e., the KPI processor 207 and event processor 209) where it is automatically processed. Each layer extracts information from the input data 203, 205 through correlation and classification phases. Input data 203, 205 can be used in each layer to “enrich” information obtained from previous layers. The final layer (i.e., the prediction and filtering layer 211) is responsible for filtering and making the final prediction.

The KPI processor 207 is a set of software functions that are responsible for processing input KPIs 203 as timeseries. The KPI processor 207 performs a classification and correlation phase on the KPI inputs 203 and is able to extract (i.e., generate) events from the KPI input 203 and to identify and organize random KPI (i.e., non-predictable KPIs) in the form of a timeseries. The event processor 209 is a set of software functions that are responsible for processing events provided as input 205, events extracted from KPIs by the KPI processor 207, as well as anomalies, and to provide events as output to the prediction and filter block 211. The outputs of the event processor are the result of different data correlation phases.

The predict and filter block 211 is a set of software functions that are responsible for processing events as input that are received directly as input 205, from KPI processor 207 (i.e., events derived from KPI, predicted anomalies (a type of event) and unpredictable KPIS), and from the event processor 209. The predict and filter block 211 performs pattern recognition and then a further correlation with input events based on models from the event processor 209. The result or output of the predict and filter block 211 is a set of alarms.

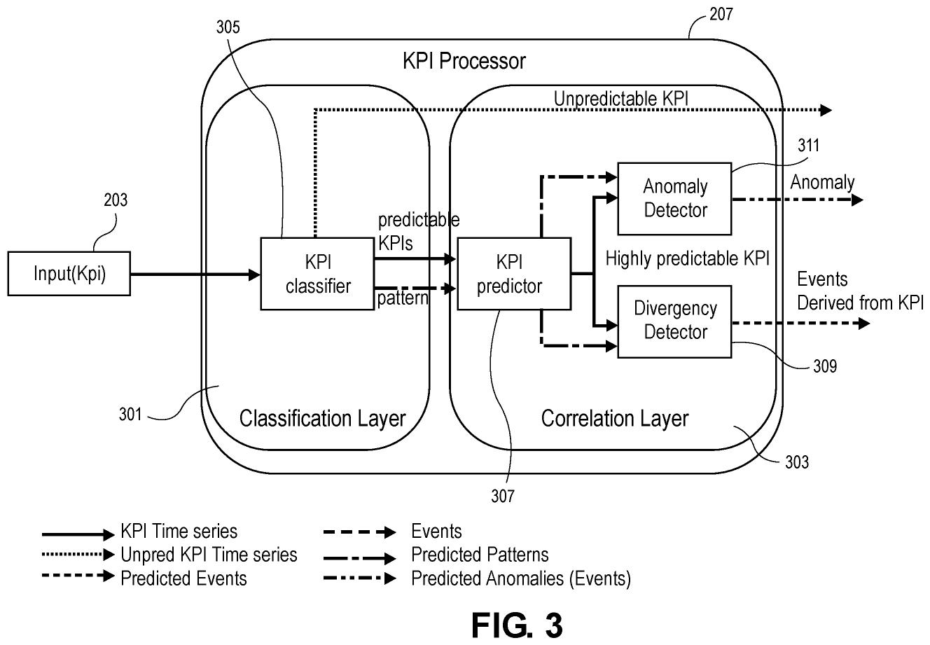

FIG. 3 is a diagram of one embodiment of a key performance indicator (KPI) processor. The KPI processor 207 receives as input a set of KPIs 203. Any number and variety of KPIs 203 can be received these KPIs can be any metric or values that are monitored or tracked in a target monitored system (e.g., bandwidth, link availability, queue lengths, and similar metrics in a monitored telecommunication network). The KPI processor 207 can be characterized as including two layers, a classification layer 301 and a correlation layer 303. For each received KPI input 203 a separate instance of the classification layer 301 and correlation layer 303 can be utilized. In other embodiments, the same instance can process multiple KPI inputs 203.

An input KPI 203 can by processed by a KPI classifier 305 in the classification layer 301, which performs a raw classification of each KPI input 203 (i.e., each different source or type of KPI) as being predictable or unpredictable KPI (i.e., a random KPIs). An ‘unpredictable KPI’ as used herein refers to a KPI input for which a pattern has not been identified by the incident management system. Predictable KPIs are KPI inputs 203 that follow known recurrent patterns. Unpredictable KPIs are KPI inputs that are sporadic, not recurrent (or without a known recurrent pattern) and for which it is required to find a cause, correlation, or pattern. In some embodiments, the KPI classifier 305 checks how well the KPIs can be predicted (i.e., determines or rates predictability). The KPI classifier 305 operates over multi-variate time series and checks how much the time series are predictable in time. In some example embodiments, a KPI classifier 305 can be implemented as a vector autoregressive (VAR)/seasonal autoregressive integrated moving average (SARIMA) process or long short-term memory (LSTM) network.

In one embodiment, the first class of data (i.e., predictable KPIs) goes to the subsequent layer of the KPI processor 207, namely, the correlation layer 303. Unpredictable KPIs are instead output by the KPI processor 207 and received as input by the event processor. The correlation layer 303 is responsible for extracting events and anomalies from predictable KPIs. The correlation layer 303 includes a KPI predictor 307, anomaly detector 311, and divergency detector 309. In some embodiments, the KPI predictor 307 receives an indication of the prediction model from the KPI classifier 305 and predicts the next KPI values for the timeseries. The prediction model to compute the KPI future values can include VAR/SARIMA, LSTM, and similar prediction models. The output of the KPI predictor 307 can be an updated timeseries with the predicted values or just the set of predicted values that are provided to the anomaly detector 311 and the divergency detector 309.

The anomaly detector 311 is a software function that compares the predicted KPI values and the actual KPI values to decide if the actual values can be considered as an anomaly of the system. In some embodiments, the actual KPI values are considered to be within an acceptable range (i.e., not anomalies) where these actual KPI values stay within a pre-defined variance (i.e., within a range) of the predicted KPI. For example, if the predicted value is 100 and the variance is 10, the actual values would need to stay within 90-110 to be in the acceptable range. VAR/SARIMA, LSTM, and similar models can be utilized as part of the comparison of the predicted and actual KPI values. Where the predicted KPI values are outside a ranged of the actual KPI values or similarly differ from the actual KPI values, then the input KPI values can be considered as anomalies and anomaly events or similar representations can be generated and output by the anomaly detector 311.

The divergency detector 309 is a software function that checks if the predicted values of the predictable KPIs cross KPI limits or warning/error thresholds specific to the type of the KPI. Each KPI type or input source can have a defined set of thresholds or limits associated with the normal operation of the target system (e.g., latency on a given link being within an accepted range). Where the KPI is predicted to exceed the thresholds or limits then an event can be generated that represents the divergence. The events can encode the type, timing, degree, and similar aspects of the divergence. These generated events are output to the event processor along with anomaly events, and unpredictable KPIs.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

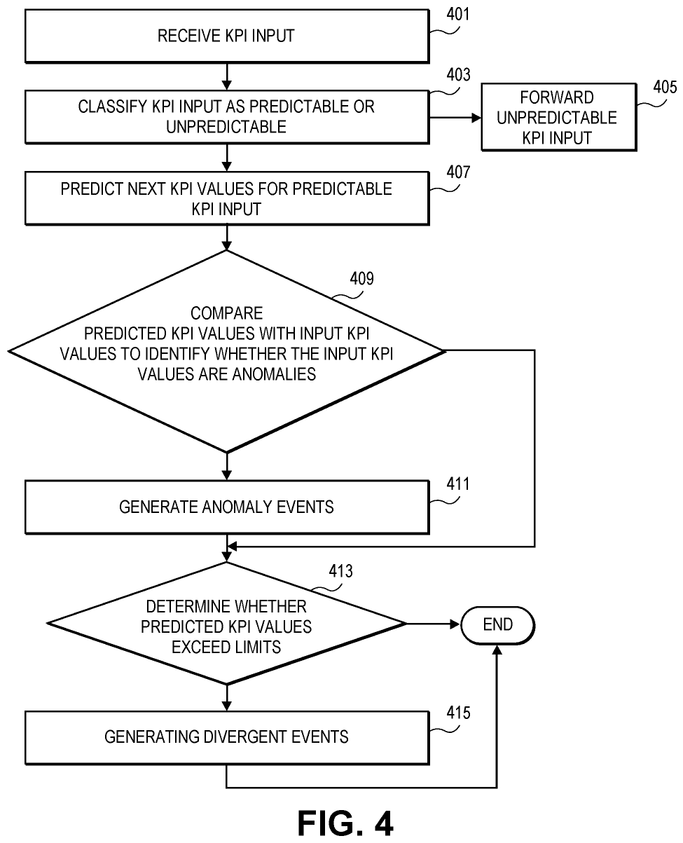

FIG. 4 is a flowchart of one embodiment of a process of the KPI processor. The flowchart represents an example of the operation of the KPI processor for a given KPI input in the form of a timeseries of metrics of a target system. The KPI processor receives the KPI input to be processed as a complete timeseries, in a continuous real-time receipt of the timeseries, or in combinations thereof (Block 401). The KPI classifier classifies the received KPI input as being either predictable or unpredictable (Block 403). The classification can be based on the type of the KPI input, analysis of the received input for patterns (e.g., using pattern matching), or using similar techniques. Where the KPI input is identified as being unpredictable, then the KPI input is output to the next layer (i.e., the event processor) (Block 405).

Where the KPI input is identified as a predictable KPI input, then the KPI predictor can generate a predicted set of KPI values based on the KPI input (Block 407). The predicted KPI values can be those values expected to occur subsequent to the received timeseries or can overlay with some aspects of the received timeseries. The predicted KPI values can then be compared with the input KPI values to identify whether the input KPI values are anomalies (Block 409). Where the input values and predicted values indicate inconsistencies in the expected pattern then an anomaly event can be generated (Block 411). The anomaly event can include information about the deviation from the expected pattern, type/classification, or similar information. Anomaly detection and event generation can be implemented by an anomaly detector in the correlation layer of the KPI processor.

If an anomaly is not detected or after the generation of the anomaly event, the KPI correlation layer can determine whether predicted KPI values exceed or deviate from a set of predefined limits or thresholds (Block 413). In some implementations the determination of whether the KPI values exceed limits (Block 413) and the comparison of the predicted KPI values can be done in the opposite order, in parallel or in other configurations. The illustrated example sequence is provided by way of illustration and not limitation. If the predicted KPI values do not exceed the pre-defined limits or thresholds then the processing of the KPI inputs completes. If the predicted KPI values do exceed the pre-defined limits or thresholds, a divergent event is generated (Block 415). The divergent event can include information such as the type of the event, the limit or threshold exceeded, the duration or degree to which the limit or threshold is exceeded, or similar information that can be informative of the detected deviation in the predicted KPI values. In some embodiments, the limits or thresholds can be a defined range of operation such that predicted KPI values that fall either below, above, or otherwise outside the pre-defined range can trigger the creation of the divergence event. The divergency detector can detect the limit or threshold deviation and can output the divergence events to the next layer of the event processor.

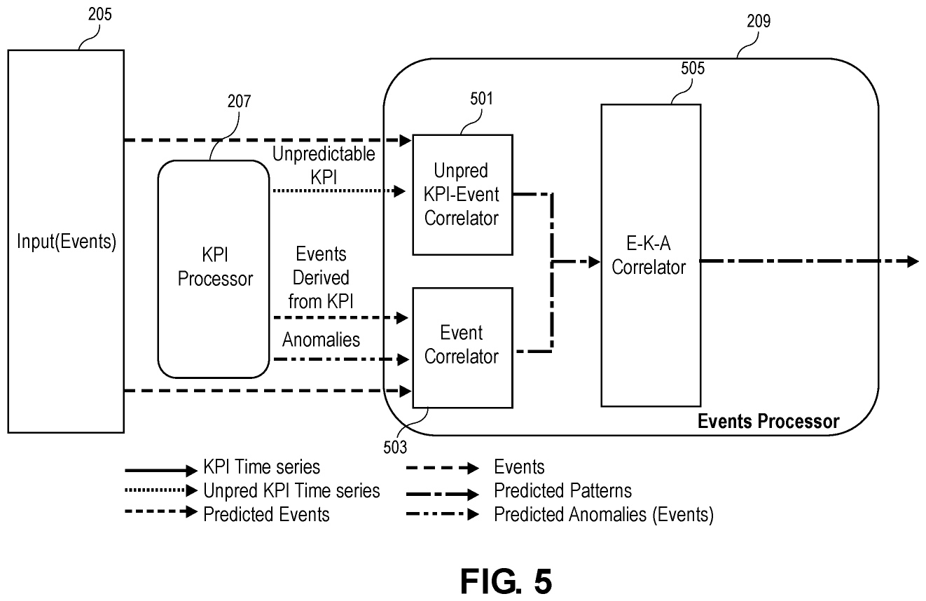

FIG. 5 is a diagram of one embodiment of an events processor. The events processor 209 receives events from the set of input events 205, events from the KPI processor 207, and unpredictable KPIs from the KPI processor 207. The input events 205 can be events generated by a monitor system. The events can be of any type and include any range of information that describes or provides metrics related to these events. Similarly, the events received from the KPI processor 207 include divergence events and anomaly events. Unpredictable KPIs are also received from the KPI processor 207.

The events processor 209 can include an unpredicted KPI event correlator 501, an event correlator 503, and an Event-KPI-Anomaly (E-K-A) correlator 505. The unpredictable-KPI event correlator 501 receives the unpredictable KPIs from the KPI processor 207 as well as event from the inputs 205. The unpredictable-KPI event correlator 501 checks the correlation among events and unusual patterns in KPIs that are classified as unpredictable. The unpredictable-KPI event correlator 501 searches and analyzes the unpredictable KPIs and seeks to identify whether the same unusual pattern of KPIs is found to precede before any type of event (e.g., in the set of input events). The output of the unpredictable-KPI event correlator is a set of models to predict events based on the unpredictable KPIs.

The event correlator 503 receives the divergence events, anomaly events, and the input set of events 205. The event correlator 503 predicts the occurrence of an event (e.g., an event from the input set of events) based on the occurrence other events. The output of the event correlator 503 is a set of models to predict a first set of event based on a second set of input events. The first set of events to be predicted can be determined based on those events found to have a predictive correlation, based on system configuration, or similar factors.

The EKA correlator 505 merges the two sets of models, the first set of models from the event correlator 503 and the second set of models from the unpredictable-KPI event correlator 501 to predict events. The models can be combined in any arrangement or order to be passed on to the prediction and filter component and there to be utilized to process the input events, anomaly events, events derived from KPIs, and unpredictable KPIs from the monitored system to generate alarms or notifications for predicted errors, outages, failures, and similar events in the monitored system.

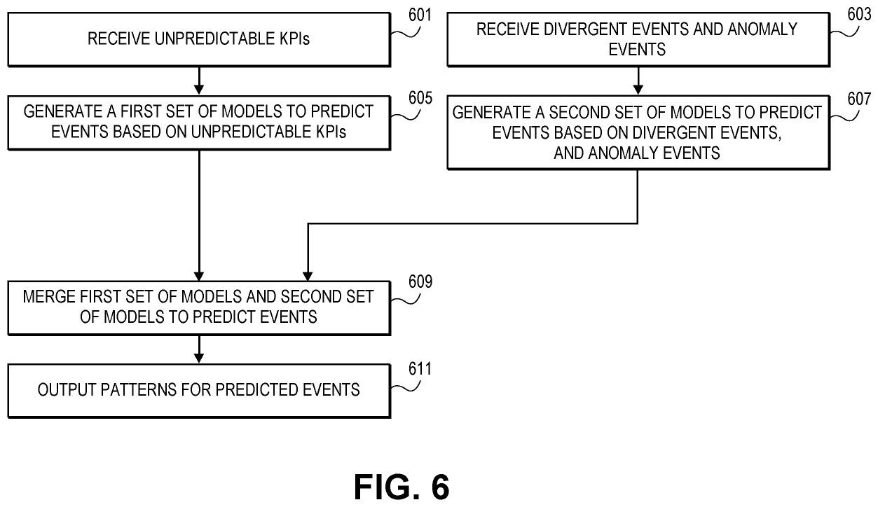

FIG. 6 is a flowchart of one embodiment of the operation of an events processor. The events processor receives a set of input events that include a set of unpredictable KPIs (Block 601) and a set of divergence events and anomaly events (Block 603) along with a general set of input events. The set of unpredictable KPIs can be received and processed in parallel to the set of divergence events and anomaly events. The set of unpredictable KPIs, divergence events, and anomaly events can be received from the KPI processor.

The unpredictable KPIs are processed to generate a first set of models to predict events based on the unpredictable KPIs (Block 605). The input events, divergent events, and anomaly events are processed to generate a second set of models to predict events based on the input events, divergent events, and anomaly events (Block 607). The first set of models are merged with the second set of models to create a combined model for predicting events based on a set of input events for the target system (Block 609). The combined model able to identify patterns for predicted events is output to be utilized by the prediction and filter component (Block 611). Due to the patterns and models generated by the E-K-A correlator, the prediction and filter block can correlate all the events in the system reducing their number and predicting the actual alarm.

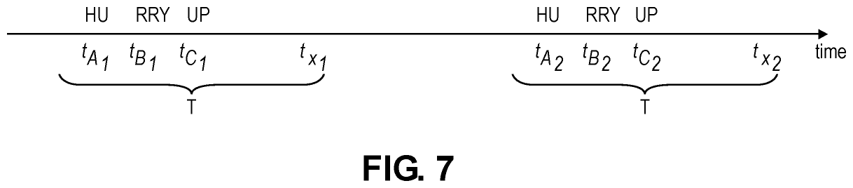

FIG. 7 is a diagram illustrating time series data. The embodiments operate over timeseries data that is input into the processes described herein. This timeseries data of events and KPIs is processed to identify correlations between these inputs and specific alarms and events that indicate problems, errors, failures, outages, and the like in the target monitored system. The reliability of the correlation between the specific alarm and events is described in relation to the example illustration. In the example, it is assumed to analyze N occurrences of a given incident (i.e., input timeseries for a KPI or event). First, the process identifies the events that are always present in a time windows T before each occurrence of a specific event. Second, the process identifies the reliability of each event. In the example case the event “HU”, that is referred to as symbol “A” for simplicity, happens at time t_{A}_{₁} within the preset inspection windows T. The event “RRY”, that is referred to as symbol “B” for simplicity, happens at time t_{B}_{₁} within the preset inspection windows T. The event “UP”, that is referred to as symbol “C” for simplicity, happens at time t_{C}_{₁} within the preset inspection windows T.

In case these events are good indicators of a future incident occurrence, their presence within T should be guaranteed (as much as possible) and their position in time too. This fact means each event (e.g., A) is expected in a specific position (in time) before the incident.

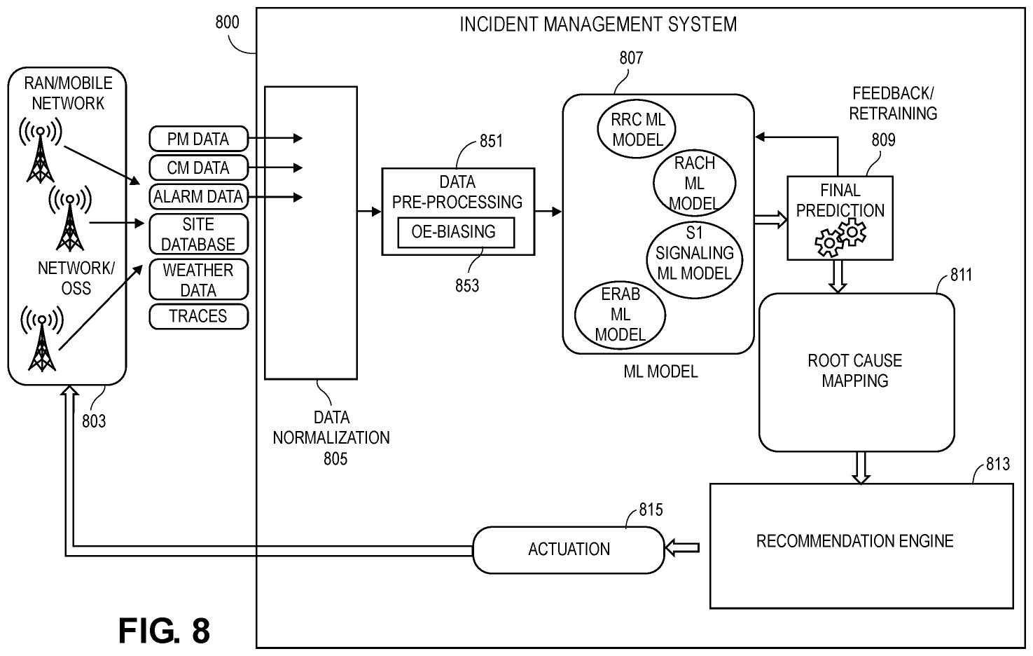

FIG. 8 is a diagram of one embodiment of an example incident management system 100. The components of the incident management system are described in relation to FIG. 8. In this example, the target system of the incident management system is a mobile network 803. The operations of the components of the incident management system are also described. The incident management system 800 works in combination with a mobile network 803 and/or radio access network of a mobile network 803. The incident management system 800 can include a data normalization unit 805, data pre-processing component 851 including a de-biasing component 853, machine learning model 807, prediction unit 809, root cause mapper 811, recommendation engine 813, and actuator 815.

The components of the incident management system 800 can be executed by any electronic device or set of electronic devices within or in communication with the mobile network 803. The mobile network 803 can include any number of electronic and network devices arrayed to provide mobile communication services to any number of UEs via a radio access network (RAN) or similar wireless communication system. The mobile network architecture can be based on any combination of 5G new radio (NR), 4G long term evolution (LTE), 3rd Generation Partnership Project (3GPP), and similar technologies. The mobile network can collect and generate a number of metrics that can be utilized for assessing cell accessibility.

Data from the mobile network 803 can include PM Counters, CM counters, alarms, traces, site database, weather data, and similar data. PM counters can include details of parameters that aid in calculation of KPIs required for the analysis. CM counters can track outliers in the parameters related to accessibility. Alarms can include events containing information about pre-defined outages in the network. For example, Quality Impacting Alarms (QIA), which are defined to capture outages related to quality of service in the network, can be utilized. QIA alarms can include global positioning system loss of time, voltage standing wave ratio (VSWR) over threshold, clock calibration expiration soon, resource activation timeout, (SFP) stability problem, temporary exceptional out of service, service degraded, radio frequency (RF) reflected power high, loss of tracking, service degraded/service unavailable, and similar QIA alarms. Outage alarms can also be utilized including network time protocol (NTP) server reachability fault, heartbeat failure, public land mobile network (PLMN) service unavailable, service unavailable, configuration requires feature activation, inconsistent configuration, resource allocation configuration, resource allocation failure, resource configuration failure, and similar outage alarms.

A site database provides details of the physical location of the site. Call Trace data can include internal events capturing UE context information and measurement reports. In some cases, trace data can provide user level information that can be used to map to problematic cells in the mobile network 800. Weather data can be data received or accessed from sources internal or external to the mobile network 800 such as specialized weather services that indicate the current weather conditions at different geographic locations. The data can be processed by a data normalization unit 805. The data normalization unit can pre-process the raw metric data that is provided by the mobile network 800. The pre-processing can normalize the data for use by the machine learning model 807. The data normalization can include computing moving averages of metrics that are used as KPIs. The moving averages can be calculated over any defined length of time or window of time. In some example embodiments, a set of preceding time periods can be utilized. For example, the preceding time period cans be the prior four hours, past day, and/or past week. These time periods can be tracked to provide insights about the impending cell behavior.

In addition to the processing of the data normalization component, the data pre-processing component 851 and de-biasing component 853 can implement the processes described herein with relation to FIG. 2-6 including the layers of the KPI event processor, and event processor. In some embodiments, the data pre-processing component 851 is incorporated into the data normalization 805. In other embodiments, the data pre-processing 851 operates on the output of the data normalization 105 as well as raw data received from the various metrics and event sources. The data pre-processing 851 can output patterns or models that can be utilized in combination with other machine learning models 107.

Each metric that is input into the machine learning models 107 can be considered a KPI for the incident management system 800. The incident management system 100 uses a different model for each KPI input or event input into the machine learning model 807. The incident management system 800 operates on the principle that there are various conditions that can lead to cell accessibility issues or similar issues relevant to the target system. The machine learning model 107 that is composed of multiple models for the different KPIs and events represents a multiclass classification-based approach that is able to capture data variations across multiple KPIs and events. Using the multiple models for processing the individual KPIs and events better correlates with cell accessibility issues to provide more specific and accurate information about a cell accessibility issue. The degradation of KPI values or events can be tied to root causes related to the cell accessibility issues enabling the identification of actuate-able solutions. The embodiments of the incident management system 800 can be focused on several KPI values or events linked to cell accessibility degradation. The machine learning models 807 that are used are composed of several machine learning models specific to each KPI or event. These machine learning models can be any type of machine learning algorithm, such as linear regression, logistic regression, decision tree, support vector machine (SVM), Naive Bayes, k nearest neighbors (kNN), random forest, K-means, dimensionality reduction algorithms, gradient boosting algorithms, and similar processes. In some embodiments, a set of different classification algorithms, trained on specific features are utilized. For example, a combination of any one or more of XGBoost, random forest, long short-term memory (LSTM), and Lightgbm can be utilized.

The combined machine learning models 807 operate on the principle that the cell accessibility issue or similar target system issues occur when there is degradation in key metrics, e.g., RRC, RACH, ERAB or S1 signaling related KPIs in this example. The RRC, RACH, ERAB and S1 signaling metrics and functions are those associated with the operation of 3^{rd} generation partnership project (3GPP) mobile networks including those implementing 4^{th} generation long term evolution (LTE) and 5^{th} generation new radio technologies. In order to address all these degradation possibilities, different machine learning models are developed. Each model focuses on specific features and learns the patterns of the KPIs or events in the mobile network 800 during a training phase. Every model is built to correlate the cell behavior with the varying KPI or event values and provide prediction for cells where threshold values are expected to be breached in an upcoming time frame (e.g., in the next 1-4 hours). The output of each model can be a binary prediction of an upcoming cell accessibility issue or similar failure or service outage issue along with a confidence interval or rating.

The prediction and filter component 809 can receive the outputs of the machine learning models 807 and process them to determine or assess the different outputs. The prediction and filter component 809 can also send feedback or training data back to the machine learning models 807. The feedback or training data can include input features along with the responses generated by the machine learning models 807. The prediction and filter component 809 can assess the important features that led to each prediction of the machine learning models 807 based on the probability by which each machine learning model produced the respective outcome. Amongst the set of deployed machine learning models, the machine learning model with the highest probability of target class (i.e., the outcome of a binary classification) is chosen and future analysis of identifying the actual root cause is conducted on the features of that model. In case the models have equal confidence scores, a tie breaking scheme can be utilized to select one of the model outputs for determination of the primary root cause. The prediction and filter component 809 outputs a selection of the cell accessibility or similar target system issues to be root cause mapped based on highest confidence level. In other embodiments, one or more of the cell accessibility issues or similar target system issues that are identified can be presented to the root cause mapper 811.

The root cause mapper 811 receives any one or more of the outputs of the machine learning models 807 after processing by the prediction and filter component 809. The feature that has highest confidence level can be selected. In some embodiments a Tree SHAP (SHapley Additive exPlanations) algorithm is used to find the root cause of the KPI indicating cell accessibility or similar target system issues. The root cause mapper traverses the decision tree to identify a recommended action to the identified root cause. In some embodiments, this mapping is generated by collecting positive interactions with Network Engineers (SMEs) to identify solutions to the root causes.

The recommendation engine 813 can apply a set of logic rules to determine whether the recommended action is to be actuated. Determination as to whether the action is taken based on predictions is based on following factors confidence Score of each prediction, consecutive count of predictions, and defined logic rules. Where the logic rules indicate actuation of the recommended action, the recommendation engine can implement the recommended action. Recommendations like cell lock/unlock, soft reset, parameter tuning, and similar action are activated in conjunction with the mobile network 803 to be actuated on the nodes of mobile network to mitigate the probable accessibility issues. In cases, the recommended action requires manual operations of the network engineers, in which case a notification is sent to the network engineers at the NOC or in a similar fashion. The process of the incident management system can operate continuously with further collection of additional mobile network 103 data.

Thus, the embodiments provide incident management system with the capability to identify and predict occurrences of issues in the target system using machine learning techniques. Automatic implementation of the recommended actions provides a closed loop solution.

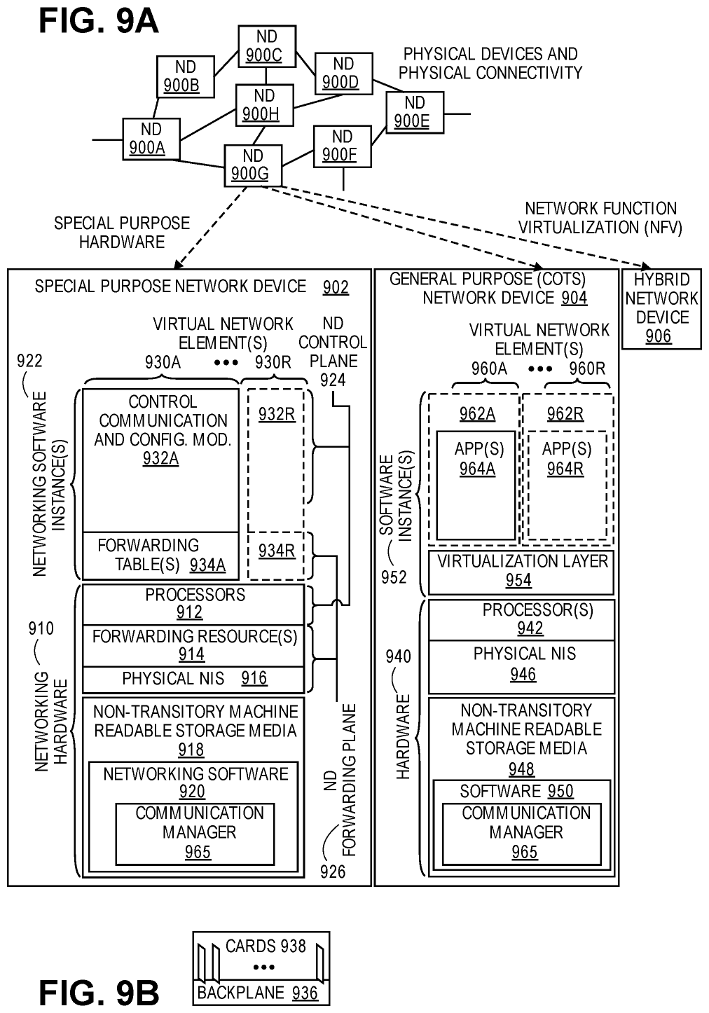

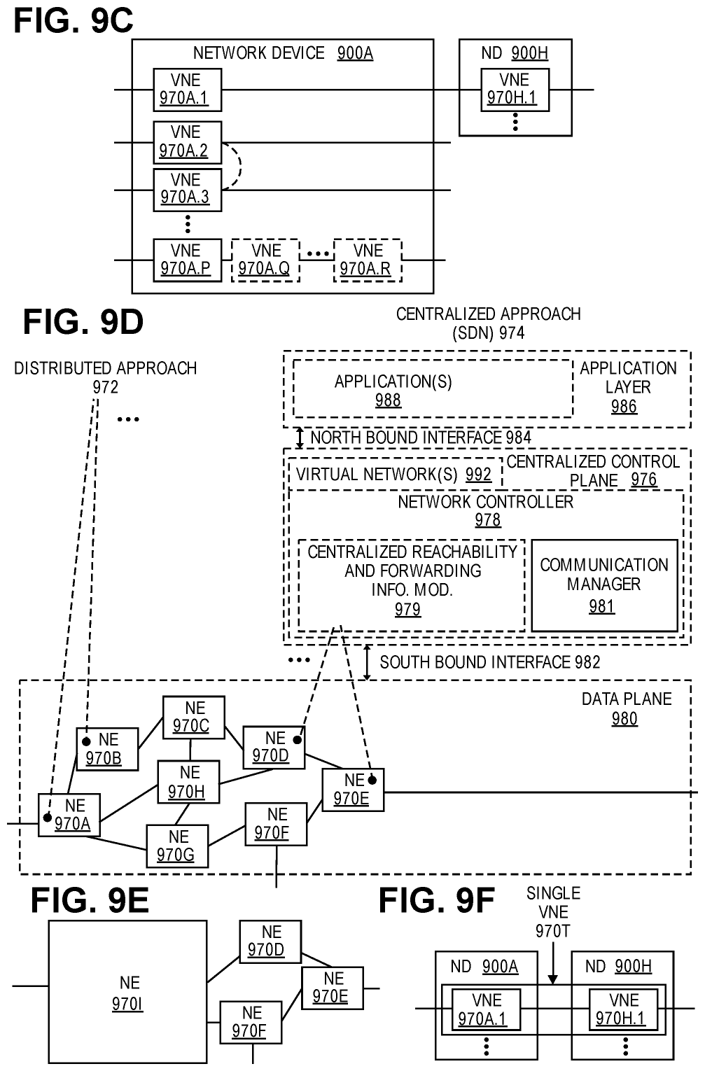

FIG. 9A illustrates connectivity between network devices (NDs) within an exemplary network, as well as three exemplary implementations of the NDs, according to some embodiments of the invention. FIG. 9A shows NDs 900A-H, and their connectivity by way of lines between 900A-900B, 900B-900C, 900C-900D, 900D-900E, 900E-900F, 900F-900G, and 900A-900G, as well as between 900H and each of 900A, 900C, 900D, and 900G. These NDs are physical devices, and the connectivity between these NDs can be wireless or wired (often referred to as a link). An additional line extending from NDs 900A, 900E, and 900F illustrates that these NDs act as ingress and egress points for the network (and thus, these NDs are sometimes referred to as edge NDs; while the other NDs may be called core NDs).

Two of the exemplary ND implementations in FIG. 9A are: 1) a special-purpose network device 902 that uses custom application-specific integrated-circuits (ASICs) and a special-purpose operating system (OS); and 2) a general purpose network device 904 that uses common off-the-shelf (COTS) processors and a standard OS.

The special-purpose network device 902 includes networking hardware 910 comprising a set of one or more processor(s) 912, forwarding resource(s) 914 (which typically include one or more ASICs and/or network processors), and physical network interfaces (NIs) 916 (through which network connections are made, such as those shown by the connectivity between NDs 900A-H), as well as non-transitory machine readable storage media 918 having stored therein networking software 920. During operation, the networking software 920 may be executed by the networking hardware 910 to instantiate a set of one or more networking software instance(s) 922. Each of the networking software instance(s) 922, and that part of the networking hardware 910 that executes that network software instance (be it hardware dedicated to that networking software instance and/or time slices of hardware temporally shared by that networking software instance with others of the networking software instance(s) 922), form a separate virtual network element 930A-R. Each of the virtual network element(s) (VNEs) 930A-R includes a control communication and configuration module 932A-R (sometimes referred to as a local control module or control communication module) and forwarding table(s) 934A-R, such that a given virtual network element (e.g., 930A) includes the control communication and configuration module (e.g., 932A), a set of one or more forwarding table(s) (e.g., 934A), and that portion of the networking hardware 910 that executes the virtual network element (e.g., 930A).

The special-purpose network device 902 is often physically and/or logically considered to include: 1) a ND control plane 924 (sometimes referred to as a control plane) comprising the processor(s) 912 that execute the control communication and configuration module(s) 932A-R; and 2) a ND forwarding plane 926 (sometimes referred to as a forwarding plane, a data plane, or a media plane) comprising the forwarding resource(s) 914 that utilize the forwarding table(s) 934A-R and the physical NIs 916. By way of example, where the ND is a router (or is implementing routing functionality), the ND control plane 924 (the processor(s) 912 executing the control communication and configuration module(s) 932A-R) is typically responsible for participating in controlling how data (e.g., packets) is to be routed (e.g., the next hop for the data and the outgoing physical NI for that data) and storing that routing information in the forwarding table(s) 934A-R, and the ND forwarding plane 926 is responsible for receiving that data on the physical NIs 916 and forwarding that data out the appropriate ones of the physical NIs 916 based on the forwarding table(s) 934A-R.

In some embodiments, data pre-processing function 965 including the de-biasing functions described herein with relation to FIGS. 2-6 can be stored in the networking software 920 in the non-transitory machine readable storage medium 918 and executed by processors 912.

FIG. 9B illustrates an exemplary way to implement the special-purpose network device 902 according to some embodiments of the invention. FIG. 9B shows a special-purpose network device including cards 938 (typically hot pluggable). While in some embodiments the cards 938 are of two types (one or more that operate as the ND forwarding plane 926 (sometimes called line cards), and one or more that operate to implement the ND control plane 924 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 936 (e.g., a first full mesh coupling the line cards and a second full mesh coupling all of the cards).

Returning to FIG. 9A, the general purpose network device 904 includes hardware 940 comprising a set of one or more processor(s) 942 (which are often COTS processors) and physical NIs 946, as well as non-transitory machine readable storage media 948 having stored therein software 950. During operation, the processor(s) 942 execute the software 950 to instantiate one or more sets of one or more applications 964A-R. While one embodiment does not implement virtualization, alternative embodiments may use different forms of virtualization. For example, in one such alternative embodiment the virtualization layer 954 represents the kernel of an operating system (or a shim executing on a base operating system) that allows for the creation of multiple instances 962A-R called software containers that may each be used to execute one (or more) of the sets of applications 964A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 954 represents a hypervisor (sometimes referred to as a virtual machine monitor (VMM)) or a hypervisor executing on top of a host operating system, and each of the sets of applications 964A-R is run on top of a guest operating system within an instance 962A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels and sets of applications that are run in different software containers).

The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual network element(s) 960A-R.

In some embodiments, data pre-processing function 965 including the de-biasing functions described herein with relation to FIGS. 2-6 can be stored in the software 950 in the non-transitory machine readable storage medium 948 and executed by processors 942.

The virtual network element(s) 960A-R perform similar functionality to the virtual network element(s) 930A-R—e.g., similar to the control communication and configuration module(s) 932A and forwarding table(s) 934A (this virtualization of the hardware 940 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 962A-R corresponding to one VNE 960A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 962A-R to VNEs also apply to embodiments where such a finer level of granularity and/or unikernels are used.

In certain embodiments, the virtualization layer 954 includes a virtual switch that provides similar forwarding services as a physical Ethernet switch. Specifically, this virtual switch forwards traffic between instances 962A-R and the physical NI(s) 946, as well as optionally between the instances 962A-R; in addition, this virtual switch may enforce network isolation between the VNEs 960A-R that by policy are not permitted to communicate with each other (e.g., by honoring virtual local area networks (VLANs)).

The third exemplary ND implementation in FIG. 9A is a hybrid network device 906, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 902) could provide for para-virtualization to the networking hardware present in the hybrid network device 906.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 930A-R, VNEs 960A-R, and those in the hybrid network device 906) receives data on the physical NIs (e.g., 916, 946) and forwards that data out the appropriate ones of the physical NIs (e.g., 916, 946). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 9C illustrates various exemplary ways in which VNEs may be coupled according to some embodiments of the invention. FIG. 9C shows VNEs 970A.1-970A.P (and optionally VNEs 970A.Q-970A.R) implemented in ND 900A and VNE 970H.1 in ND 900H. In FIG. 9C, VNEs 970A.1-P are separate from each other in the sense that they can receive packets from outside ND 900A and forward packets outside of ND 900A; VNE 970A.1 is coupled with VNE 970H.1, and thus they communicate packets between their respective NDs; VNE 970A.2-970A.3 may optionally forward packets between themselves without forwarding them outside of the ND 900A; and VNE 970A.P may optionally be the first in a chain of VNEs that includes VNE 970A.Q followed by VNE 970A.R (this is sometimes referred to as dynamic service chaining, where each of the VNEs in the series of VNEs provides a different service—e.g., one or more layer 4-7 network services). While FIG. 9C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 9A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 9A may also host one or more such servers (e.g., in the case of the general purpose network device 904, one or more of the software instances 962A-R may operate as servers; the same would be true for the hybrid network device 906; in the case of the special-purpose network device 902, one or more such servers could also be run on a virtualization layer executed by the processor(s) 912); in which case the servers are said to be co-located with the VNEs of that ND.

A virtual network is a logical abstraction of a physical network (such as that in FIG. 9A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 9D illustrates a network with a single network element on each of the NDs of FIG. 9A, and within this straight forward approach contrasts a traditional distributed approach (commonly used by traditional routers) with a centralized approach for maintaining reachability and forwarding information (also called network control), according to some embodiments of the invention. Specifically, FIG. 9D illustrates network elements (NEs) 970A-H with the same connectivity as the NDs 900A-H of FIG. 9A.

FIG. 9D illustrates that the distributed approach 972 distributes responsibility for generating the reachability and forwarding information across the NEs 970A-H; in other words, the process of neighbor discovery and topology discovery is distributed.

For example, where the special-purpose network device 902 is used, the control communication and configuration module(s) 932A-R of the ND control plane 924 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 970A-H (e.g., the processor(s) 912 executing the control communication and configuration module(s) 932A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 924. The ND control plane 924 programs the ND forwarding plane 926 with information (e.g., adjacency and route information) based on the routing structure(s). For example, the ND control plane 924 programs the adjacency and route information into one or more forwarding table(s) 934A-R (e.g., Forwarding Information Base (FIB), Label Forwarding Information Base (LFIB), and one or more adjacency structures) on the ND forwarding plane 926. For layer 2 forwarding, the ND can store one or more bridging tables that are used to forward data based on the layer 2 information in that data. While the above example uses the special-purpose network device 902, the same distributed approach 972 can be implemented on the general purpose network device 904 and the hybrid network device 906.

FIG. 9D illustrates that a centralized approach 974 (also known as software defined networking (SDN)) that decouples the system that makes decisions about where traffic is sent from the underlying systems that forwards traffic to the selected destination. The illustrated centralized approach 974 has the responsibility for the generation of reachability and forwarding information in a centralized control plane 976 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 976 has a south bound interface 982 with a data plane 980 (sometime referred to the infrastructure layer, network forwarding plane, or forwarding plane (which should not be confused with a ND forwarding plane)) that includes the NEs 970A-H (sometimes referred to as switches, forwarding elements, data plane elements, or nodes). The centralized control plane 976 includes a network controller 978, which includes a centralized reachability and forwarding information module 979 that determines the reachability within the network and distributes the forwarding information to the NEs 970A-H of the data plane 980 over the south bound interface 982 (which may use the OpenFlow protocol). Thus, the network intelligence is centralized in the centralized control plane 976 executing on electronic devices that are typically separate from the NDs.

For example, where the special-purpose network device 902 is used in the data plane 980, each of the control communication and configuration module(s) 932A-R of the ND control plane 924 typically include a control agent that provides the VNE side of the south bound interface 982. In this case, the ND control plane 924 (the processor(s) 912 executing the control communication and configuration module(s) 932A-R) performs its responsibility for participating in controlling how data (e.g., packets) is to be routed (e.g., the next hop for the data and the outgoing physical NI for that data) through the control agent communicating with the centralized control plane 976 to receive the forwarding information (and in some cases, the reachability information) from the centralized reachability and forwarding information module 979 (it should be understood that in some embodiments of the invention, the control communication and configuration module(s) 932A-R, in addition to communicating with the centralized control plane 976, may also play some role in determining reachability and/or calculating forwarding information—albeit less so than in the case of a distributed approach; such embodiments are generally considered to fall under the centralized approach 974, but may also be considered a hybrid approach).

In some embodiments, data pre-processing function 981 including the de-biasing functions described herein with relation to FIGS. 2-6 can be a part of the network controller 978 or other component of the centralized approach 974.

While the above example uses the special-purpose network device 902, the same centralized approach 974 can be implemented with the general purpose network device 904 (e.g., each of the VNE 960A-R performs its responsibility for controlling how data (e.g., packets) is to be routed (e.g., the next hop for the data and the outgoing physical NI for that data) by communicating with the centralized control plane 976 to receive the forwarding information (and in some cases, the reachability information) from the centralized reachability and forwarding information module 979; it should be understood that in some embodiments of the invention, the VNEs 960A-R, in addition to communicating with the centralized control plane 976, may also play some role in determining reachability and/or calculating forwarding information—albeit less so than in the case of a distributed approach) and the hybrid network device 906. In fact, the use of SDN techniques can enhance the NFV techniques typically used in the general purpose network device 904 or hybrid network device 906 implementations as NFV is able to support SDN by providing an infrastructure upon which the SDN software can be run, and NFV and SDN both aim to make use of commodity server hardware and physical switches.

FIG. 9D also shows that the centralized control plane 976 has a north bound interface 984 to an application layer 986, in which resides application(s) 988. The centralized control plane 976 has the ability to form virtual networks 992 (sometimes referred to as a logical forwarding plane, network services, or overlay networks (with the NEs 970A-H of the data plane 980 being the underlay network)) for the application(s) 988. Thus, the centralized control plane 976 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 9D shows the distributed approach 972 separate from the centralized approach 974, the effort of network control may be distributed differently or the two combined in certain embodiments of the invention. For example: 1) embodiments may generally use the centralized approach (SDN) 974, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 974, but may also be considered a hybrid approach.

While FIG. 9D illustrates the simple case where each of the NDs 900A-H implements a single NE 970A-H, it should be understood that the network control approaches described with reference to FIG. 9D also work for networks where one or more of the NDs 900A-H implement multiple VNEs (e.g., VNEs 930A-R, VNEs 960A-R, those in the hybrid network device 906). Alternatively or in addition, the network controller 978 may also emulate the implementation of multiple VNEs in a single ND. Specifically, instead of (or in addition to) implementing multiple VNEs in a single ND, the network controller 978 may present the implementation of a VNE/NE in a single ND as multiple VNEs in the virtual networks 992 (all in the same one of the virtual network(s) 992, each in different ones of the virtual network(s) 992, or some combination). For example, the network controller 978 may cause an ND to implement a single VNE (a NE) in the underlay network, and then logically divide up the resources of that NE within the centralized control plane 976 to present different VNEs in the virtual network(s) 992 (where these different VNEs in the overlay networks are sharing the resources of the single VNE/NE implementation on the ND in the underlay network).

On the other hand, FIGS. 9E and 9F respectively illustrate exemplary abstractions of NEs and VNEs that the network controller 978 may present as part of different ones of the virtual networks 992. FIG. 9E illustrates the simple case of where each of the NDs 900A-H implements a single NE 970A-H (see FIG. 9D), but the centralized control plane 976 has abstracted multiple of the NEs in different NDs (the NEs 970A-C and G-H) into (to represent) a single NE 9701 in one of the virtual network(s) 992 of FIG. 9D, according to some embodiments of the invention. FIG. 9E shows that in this virtual network, the NE 9701 is coupled to NE 970D and 970F, which are both still coupled to NE 970E.

FIG. 9F illustrates a case where multiple VNEs (VNE 970A.1 and VNE 970H.1) are implemented on different NDs (ND 900A and ND 900H) and are coupled to each other, and where the centralized control plane 976 has abstracted these multiple VNEs such that they appear as a single VNE 970T within one of the virtual networks 992 of FIG. 9D, according to some embodiments of the invention. Thus, the abstraction of a NE or VNE can span multiple NDs.

While some embodiments of the invention implement the centralized control plane 976 as a single entity (e.g., a single instance of software running on a single electronic device), alternative embodiments may spread the functionality across multiple entities for redundancy and/or scalability purposes (e.g., multiple instances of software running on different electronic devices).

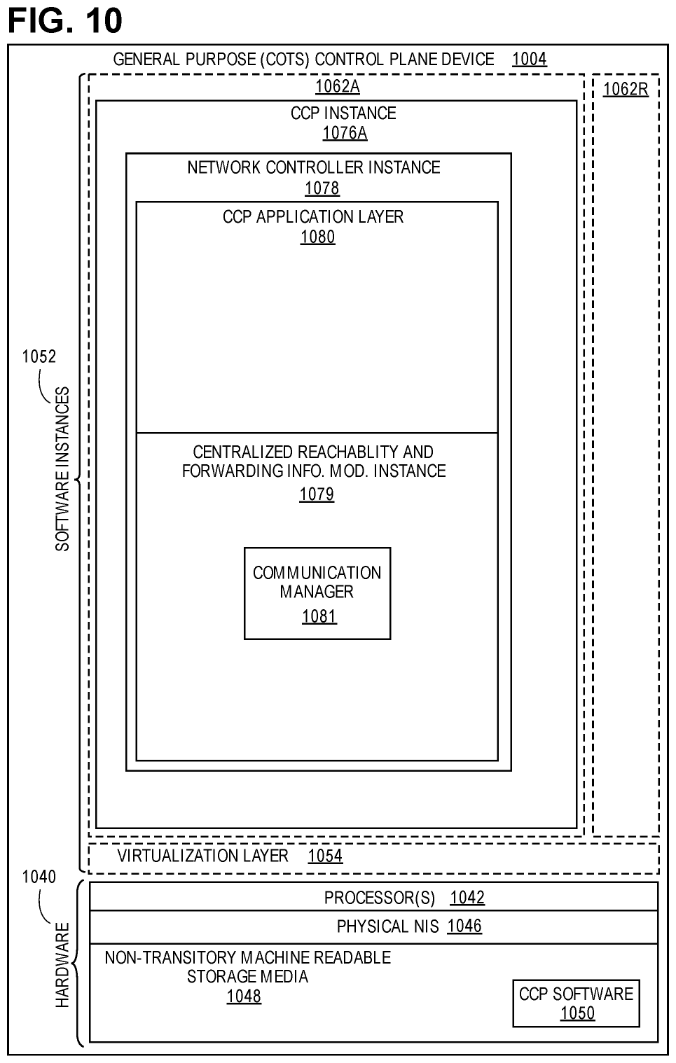

Similar to the network device implementations, the electronic device(s) running the centralized control plane 976, and thus the network controller 978 including the centralized reachability and forwarding information module 979, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 10 illustrates, a general purpose control plane device 1004 including hardware 1040 comprising a set of one or more processor(s) 1042 (which are often COTS processors) and physical NIs 1046, as well as non-transitory machine readable storage media 1048 having stored therein centralized control plane (CCP) software 1050.

In some embodiments, data pre-processing function 1081 including the de-biasing functions described herein with relation to FIGS. 2-6 can be stored in the software in the non-transitory machine readable storage medium 1048 and executed by processors 1042.

In embodiments that use compute virtualization, the processor(s) 1042 typically execute software to instantiate a virtualization layer 1054 (e.g., in one embodiment the virtualization layer 1054 represents the kernel of an operating system (or a shim executing on a base operating system) that allows for the creation of multiple instances 1062A-R called software containers (representing separate user spaces and also called virtualization engines, virtual private servers, or jails) that may each be used to execute a set of one or more applications; in another embodiment the virtualization layer 1054 represents a hypervisor (sometimes referred to as a virtual machine monitor (VMM)) or a hypervisor executing on top of a host operating system, and an application is run on top of a guest operating system within an instance 1062A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 1040, directly on a hypervisor represented by virtualization layer 1054 (in which case the unikernel is sometimes described as running within a LibOS virtual machine), or in a software container represented by one of instances 1062A-R). Again, in embodiments where compute virtualization is used, during operation an instance of the CCP software 1050 (illustrated as CCP instance 1076A) is executed (e.g., within the instance 1062A) on the virtualization layer 1054. In embodiments where compute virtualization is not used, the CCP instance 1076A is executed, as a unikernel or on top of a host operating system, on the “bare metal” general purpose control plane device 1004. The instantiation of the CCP instance 1076A, as well as the virtualization layer 1054 and instances 1062A-R if implemented, are collectively referred to as software instance(s) 1052.

In some embodiments, the CCP instance 1076A includes a network controller instance 1078. The network controller instance 1078 includes a centralized reachability and forwarding information module instance 1079 (which is a middleware layer providing the context of the network controller 978 to the operating system and communicating with the various NEs), and an CCP application layer 1080 (sometimes referred to as an application layer) over the middleware layer (providing the intelligence required for various network operations such as protocols, network situational awareness, and user—interfaces). At a more abstract level, this CCP application layer 1080 within the centralized control plane 976 works with virtual network view(s) (logical view(s) of the network) and the middleware layer provides the conversion from the virtual networks to the physical view.

The centralized control plane 976 transmits relevant messages to the data plane 980 based on CCP application layer 1080 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 980 may receive different messages, and thus different forwarding information. The data plane 980 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 980, the packet (or a subset of the packet header and content) is typically forwarded to the centralized control plane 976. The centralized control plane 976 will then program forwarding table entries into the data plane 980 to accommodate packets belonging to the flow of the unknown packet. Once a specific forwarding table entry has been programmed into the data plane 980 by the centralized control plane 976, the next packet with matching credentials will match that forwarding table entry and take the set of actions associated with that matched entry.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method for de-biasing data for an incident management system, the method comprising:
receiving a key performance indicator (KPI) input from at least a first source and a second source;
classifying the key performance indicator input as a predictable KPI or an unpredictable KPI;
generating a first set of models to predict events based on the unpredictable KPI;
executing the first set of models to generate predicted events for the incident management system; and
outputting a set of patterns for the predicted events.

2. The method of claim 1, further comprising:
predicting subsequent KPI values for the first source where the KPI input of the first source is classified as predictable;
comparing predicted subsequent KPI values for the first source with the KPI input of the first source to identify anomalies; and
generating anomaly events for the incident management system in response to identifying the anomalies.

3. The method of claim 1, further comprising:
predicting subsequent KPI values for the first source where the KPI input of the first source is classified as predictable;
determining whether the predicted subsequent KPI values for the first source exceed a predefined limit; and
generating divergence events for the incident management system in response to determining that the predicted subsequent KPI values for the first source exceed the predefined limit.

4. The method of claim 1, further comprising:
generating a second set of models to predict events based on divergence events and anomaly events.

5. The method of claim 4, further comprising:
merging the first set of models and the second set of models to predict events for the incident management system.

6. A non-transitory machine-readable storage medium having stored therein a set of instructions for a method for de-biasing data for an incident management system, which when executed by a processor of an electronic device cause the electronic device to perform a set of operations comprising:
receiving a key performance indicator (KPI) input from at least a first source and a second source;
classifying the key performance indicator input as a predictable KPI or an unpredictable KPI;
generating a first set of models to predict events based on the unpredictable KPI;
executing the first set of models to generate predicted events for the incident management system; and
outputting a set of patterns for the predicted events.

7. An electronic device comprising
a machine-readable storage medium having stored therein a de-biasing component; and
a set of processors coupled to the machine-readable storage medium, at least one processor from the set of processors to execute the de-biasing component, the de-biasing component to execute the method for de-biasing data for an incident management system, where the method includes receiving a key performance indicator (KPI) input from at least a first source and a second source, classifying the key performance indicator input as a predictable KPI or an unpredictable KPI, generating a first set of models to predict events based on the unpredictable KPI, executing the first set of models to generate predicted events for the incident management system, and outputting a set of patterns for the predicted events.
